(19) United States
(12) Patent Application Publication
(10) Pub. No.: US 2010/0073162 A1
(43) Pub. Date: Mar. 25, 2010

(54) HAND WASHING REMINDER DEVICE AND METHOD

(76) Inventors: Michael David Johnson, Friendswood, TX (US); Robert Louis Clark, JR., Johnston, TX (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/554,680

(22) Filed: Sep. 4, 2009

Related U.S. Application Data
(60) Provisional application No. 61/191,095, filed on Sep. 5, 2008.

(51) Int. Cl. G08B 21/00

(52) U.S. Cl. 340/540

(57) ABSTRACT

A device and method for reminding people to maintain hand hygiene. Further a device and method for reminding people to perform hand washing and obtaining hand hygiene compliance data in a patient care environment, which may be a hospital, a nursing home, or a food service facility, which may be a restaurant or cafeteria. A device and method for using accelerometry and/or additional sensor cues, which may include the sound of running water and/or alcohol odor, for sensing when a person has washed their hands, and for using accelerometry information and other cues to determine when a person has touched something, thereby contaminating his/her hands.

### CROSS-REFERENCE TO RELATED APPLICATIONS

This application also claims the benefit of priority of U.S. provisional patent application No. 61/191,095 entitled “HAND WASHING REMINDER DEVICE AND METHOD” filed Sep. 5, 2008.

### FIELD

The present disclosure relates in general to systems and methods for reminding people to maintain hand hygiene, and more particularly, to systems and methods for reminding people to perform hand washing and obtaining hand hygiene compliance data in a patient care environment, which may include, but is not limited to, a hospital, a nursing home, or a food service facility, which may include, but is not limited to, a restaurant or cafeteria.

### DESCRIPTION OF THE RELATED ART

Substantial literature exists on infections, including nosocomial infections, which are prevalent in all patient care facilities including hospitals and nursing homes. These infections pose a significant health risk to hospitalized patients by delaying healing, extending the length of hospitalization and increasing the human and financial cost of care. A nosocomial infection has been defined as “a localized or systemic condition that 1) resulted from adverse reaction to the presence of an infectious agent or its toxin and 2) was not present or incubating at the time of admission to the hospital.” Research reveals that several types of microorganisms can be transferred by hand to live hosts, thereby producing nosocomial infections.

Nosocomial infections delay healing, extend the length of hospitalization and increase the cost of care. Each year, approximately 2.4 million Americans acquire a nosocomial infection and 100,000 persons die as a result of such infections.

Hand washing is the linchpin of infection control. Failure to conduct hand washing after toileting or prior to contact with a patient places patients and health care workers at great risk for the development of nosocomial infections. While health care workers play a powerful role in reducing nosocomial infections, they have also been implicated in contributing to their increase by failing to perform hand washing prior to contact with a patient and after handling contaminated materials. Although health care workers are required to participate in annual infection control in service inspections, there is a discrepancy between classroom knowledge and applied knowledge of infection control. This discrepancy suggests that innovative strategies in infection control must be created in order to reduce the rate of nosocomial infections.

In the case of the activity of hand washing, almost all people exhibit a combination of a fairly vigorous hand motion (i.e. rubbing motion) and a “rolling” scrubbing motion. The frequency of both motions is fairly consistent between all humans and may be related to some form of universal human autonomic system functionality. Drying of the hands with a towel may also be sensed using accelerometry due to the unique motion of hand drying to sense the termination of the hand washing sequence. In combination with the scrubbing action of the person hand washing also involves the use of running water which creates white noise spectra that is specific in nature and easy to detect via an audio transducer and some form of fast Fourier transform (FFT) or bandpass filter analysis. The presence of moisture is also an indication of hand washing. Proper hand washing with water is accompanied with soap which emits a characteristic odor. Some establishments use hand dryers which emit a characteristic sound that could be used to indicate the termination of the hand washing sequence. Modern hospitals and restaurants also use alcohol based hand washing solutions, which may be in place of running water and soap, that may emit a characteristic alcohol odor upon application of the cleaner to the hands combined with the previously discussed hand scrubbing motions.

Further information regarding accelerometry, a method known in the prior art wherein the motions of a person's appendages are recorded via multi-axis accelerometers to determine the type of activity the person is engaged in is described in literature. For example, N. M. Herbst and C. N. Liu in “Automatic Signature Verification Based on Accelerometry”, IBM Journal of Research and Development, May 1977, pp. 245-253, J. S. Lew in “An improved regional correlation algorithm for signature verification which permits small speed changes between handwriting segments”, IBM Journal of Research and Development, March 1983, Vol. 27, No. 2, pp. 245-253, and U.S. Pat. No. 3,983,535 each utilize the accelerometry of pen motions to verify the identity of a signatory. The unique motions of a pen during the process of generating a signature are very difficult to forge and this method of verification boasts an error rate of only 0.16 percent; thus, this type of accelerometry is a very effective method of identifying specific body motions.

A less complicated system of accelerometry is outlined in P. H. Veltink, et. al., “The Feasibility of Posture and Movement Detection by Accelerometry”, IEEE 0-7803-1377-1/93, 1993, pp. 1230-1231. In this method, a plot of two acceleration sensor outputs is correlated to various activities such as sitting, standing and lying. Each of these activities produces a unique combination of acceleration plots and the general clustering of these plots tends to correlate with a specific activity. The acceleration data is filtered with a low pass filter prior to plotting to remove higher frequency components that were not associated with the gross motor movements of the person.

Other methods of sensing body motion include the use of miniature gyroscopes or ultrasound Doppler velocitometry. In the ultrasound Doppler velocitometry method, an ultrasonic transducer emits ultrasound pulses that are reflected back to a receiver. When any ultrasound reflective object moves within the pulse field of view, a Doppler shift may be sensed indicating the objects velocity magnitude and receding or advancing motion.

A more full understanding regarding the field of this disclosed subject matter appears in U.S. Pat. No. 7,372,367, which discloses a hand washing and monitoring system that measures hand hygiene compliance by maintaining a computer database, and determining whether any person entered a first area via a sensor located in the first area. U.S. Pat. No. 7,372,367 also includes the steps of determining whether the person left the first area and entered a second area and determining whether the any person performed hand hygiene before leaving the first area. The method includes the step of sending information associated with whether the any person performed hand hygiene before leaving the first area to the computer database.

Further, U.S. Pat. No. 6,727,818 discloses a method of monitoring hygiene compliance comprising the steps of receiving first location information, which tracks movement and hand washing information, determining whether a person who has entered a patient contact zone has washed their hands since their most recent exposure to a contamination zone, and updating compliance information for the person based upon the determining step.

U.S. Pat. No. 5,945,910 discloses a hand washing and monitoring system that uses a sensor that signals the dispensation of a cleaning agent from a dispenser. A dual mode monitoring and reporting module includes an input element, an output element, a processor, and memory. The module accepts data identifying an employee, receives a signal indicating dispensation of the cleaning agent and stores compliance data records.

Further, U.S. Pat. No. 5,870,015 discloses an apparatus in which toilet use is monitored and audible messages are produced that instruct users of the toilet regarding steps in toilet use and hygiene. The apparatus includes a housing that is removably attached to the toilet. A switch arm is coupled with the toilet handle and sends an activity signal indicative of the switch arm position to electronic circuitry that activates the audible messages.

U.S. Pat. No. 5,812,059 discloses a method and system for enhancing hygiene. An activating device is located outside a work area, a hand cleaning station is located near the work area, and a deactivating device is associated with the hand cleaning station. Upon leaving a food handling area, an indicator worn by a worker is activated when the worker is near the activating device. The indicator is deactivated only when it is determined that the worker has used the hand cleaning station.

Further, U.S. Pat. No. 5,202,666 discloses an automated device used to remind employees to wash their hands after toileting. Sensors are worn on credit card sized badges and mounted in bathroom ceilings and attached to soap dispensers and sinks. When an employee enters the bathroom, the ceiling unit sensor activates a blinking light on the badge. The light is deactivated once the employee pumps the soap dispenser and stands in front of the sink for at least 15 seconds.

U.S. Pat. No. 4,986,144 discloses a hand washing alert warning system designed to warn someone to wash their hands. A door activate system is armed when the door to the wash facility is opened or a toilet is flushed and is deactivated when it is determined that the person has washed their hands.

Further, detection of running water using noise spectra is well known in the prior art. The frequency spectrum of water running from a faucet into a sink is generally a constant energy envelope from 0 to 5 kHz range with a sharp drop off above 5 kHz. This noise is generated from air bubbles and cavitation bubbles in the running water stream. Further, detection of moisture is well known in the prior art and may consist of a water absorbent material placed between two electrodes. Further, detection of alcohol odor is well known in the prior art. U.S. Pat. No. 3,940,251 describes a fuel cell based alcohol odor detector that is capable of detecting alcohol odor in the air and is sufficient to detect the alcohol odor from a hand scrub solution as commonly used in a hospital or food service setting.

In systems and methods for reminding people to maintain hand hygiene, there is need for improvement in the way to monitor what a person does between the time they wash their hands and the time they return to their work area.

A further need exists to overcome the problem of requiring a complex facility based system, which typically requires interaction with a person who is wearing a sensor or a passive indicating device.

There is a further need to monitor what a person does between the time they wash their hands and the time they return to their work area in a simple and cost-effective manner.

Still further improvement is needed in indicating the hand wash state of a person.

### SUMMARY

The present disclosure shows a device and method for reminding people of hand hygiene compliance that meets and/or satisfies the aforestated concerns.

In accordance with the disclosed subject matter, an improved method to obtain hand hygiene compliance data without the use of complex facility based systems. The present disclosure teaches an apparatus for reminding hand hygiene compliance, which may include, but is not limited to, detecting whether a person has washed their hands or touched an object, indicating the hand wash state of the user, and optionally transmitting data to a central computer database. The present disclosure further describes a sensing portion for detecting the washing or drying of person's hands. Further, the sensing portion of the present disclosure teaches the unique combination of sensing scrubbing hand motion and/or the sound of running water and/or odor of soap or scrubbing hand motions and the presence of alcohol odor. In accordance with the disclosed subject matter, the termination of the hand washing sequence may be sensed by either towel drying motion, the sound of an air dryer or the absence, which may be due, but is not limited to evaporation of alcohol. More specifically, a device and method for detecting hand washing and drying that may comprise at least one multi-axis accelerometer, gyroscope, or ultrasonic Doppler velocitometer, otherwise known as motion sensors, which may be located on an appendage of the user, which may be the wrist of either or both hands, a sound detector, which may be a microphone, and an alcohol odor detector, which may be a fuel cell detector. The device and method for sensing whether a person has touched something may be accomplished via accelerometry data collected by a multi-axis accelerometer, a gyroscope, or an ultrasonic Doppler velocitometry sensor. More particularly, the present disclosure teaches a specific characteristic accelerometer spectra that resembles a shock like event, which may be, but is not limited to, an abrupt termination of motion of the hand or arm, when a person touches any object with his/her hands.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality.

### BRIEF DESCRIPTION OF DRAWINGS

The objects and advantages of embodiments of the present invention are apparent from the following detailed descriptions of preferred embodiments in connection with the accompanying drawings in which like numerals designate like elements, and in which:

FIG. 1 shows an illustration of the device and process flow according to a disclosed embodiment of the present invention.

FIG. 1a displays an illustration of the device and process flow according to a disclosed embodiment of the present invention.

FIG. 2 provides an illustration of the system in use according to a disclosed embodiment of the present invention.

### DETAILED DESCRIPTION

The present disclosure describes a device and method for reminding people of hand hygiene compliance without the use of complex facility based systems.

In describing embodiments of the present invention illustrated in the drawings, specific terminology is employed for the sake of clarity.

In the present disclosure, the phrase “dirty hands” may refer to any foreign object that is not a cell or tissue of the human body. Further, the phrase “dirty hands” may refer to hands of a subject that may be associated with, but is not limited to, dust, dirt, contamination, debris, or fecal matter, among others particles associated with dirtiness. The phrase “clean hands” may refer to the lack of dust, dirt, contamination, debris, or fecal matter, among others particles associated with dirtiness.

Further, the phrase “dirty hands” excludes the legal doctrine of unclean hands, sometimes referred to in legal contexts as the dirty hands doctrine, which is an equitable defense in which the defendant argues that the plaintiff is not entitled to obtain an equitable remedy on account of the fact that the plaintiff is acting unethically or has acted in bad faith with respect to the subject of the complaint, that is with unclean hands as it is known in legal contexts.

Further, the disclosed subject matters focuses primarily on ensuring hand hygiene compliance, but it is to be understood that the concepts presented also allow significant improvement in sensing the contamination of a person's hand, and also of wirelessly transmitting data to a system for data collection, when appropriately implemented. Further, a collection system may refer to, but is not limited to, a magnetic tape recorder, a paper recorder, a flash memory recorder, an internal memory of a microcontroller, a printer, or a data logger, among others.

Further, the disclosed subject matter significantly improves the monitoring what a person does in between the time the person washes his/her hands and the time that he/she returns to his/her work area, while indicating the hand wash state.

The following listing of specific embodiments discussed herein are merely illustrative of specific ways to make and use the present disclosure and do not delimit the scope of the present disclosure.

The present disclosure illustrates, either singly or jointly, the specific hand washing motion and the sound of running water or the combination of the specific hand washing motion and the presence of alcohol odor may indicate that hand washing is occurring.

The present disclosure may also measure the duration of hand washing, which may be in addition to the detection of hand washing. Thus, the present disclosure may further enhance compliance with hand washing regulations, since a traditionally accepted minimum duration of hand washing is required to sufficiently clean one's hands. The presently disclosed subject matter describes detection of towel or air dryer drying of the hands using accelerometry data, which may be used to indicate the termination of the hand washing session. Any combination of sensed activities may be implemented to sense the intended activity of hand washing.

In an exemplary embodiment of the present disclosure, a method of sensing the hand washing or drying motion, which may use an accelerometer or gyroscope, which may be, but is not limited to, being located near the user's pectoral muscle. For example, the hand washing sensor accelerometer or gyroscope set, which may be, but is not limited to, may be housed in a badge worn on the lapel of a uniform in proximity to one of the user's pectoral muscles. The pectoral muscles exhibit a unique motion during hand washing and drying. This method of sensing hand washing and drying motion may be less cumbersome than a bracelet to the user of the device.

Still another embodiment of the present disclosure teaches a method of sensing hand washing motion that may use an ultrasonic Doppler velocitometer sensor, which may be, but is not limited to, being located on the user's chest. For example, the hand washing ultrasonic Doppler velocitometer sensor set may be housed in a badge worn on the lapel of a uniform so the sensor has a field of view including the user's hands and arms. The ultrasonic Doppler velocitometer sensor may detect hand and arm motion via Doppler velocitometry. The hand washing and drying motions may generate unique Doppler velocitometry spectra that may be used by a signal processor to identify hand washing and drying activity. This method of sensing hand washing and drying motion may be less cumbersome than a bracelet to the user of the device.

Yet another exemplary embodiment of the present disclosure teaches a microphone that feeds a simple envelope detector may suffice to detect the presence of running water, which may be associated with water from a faucet. The combination of a microphone and a simple envelope detector may serve as a running water detector. This method may also be used to detect the sound of an air hand dryer. This information may be used to indicate the termination of the hand washing session.

Further, the present subject matter teaches detection of moisture, which may result from wet hands, with an indicator that may become conductive or may generate a small voltage to indicate the presence of moisture which may define a moisture detector. Further, the present subject matter teaches detection of alcohol odor with the use of liquid or bar soap that may be combined with a unique tracer chemical that may be matched to a detector of the disclosed subject matter to indicate the presence of soap.

In accordance with the disclosed subject matter, a device and method for sensing a “dirty hands” condition. A method of preventing the “dirty hands” trigger from starting too soon by placing a time delay into the system before it is possible to activate the “dirty hands” indicator; this delay may be, but is not limited to being, on the order of thirty seconds or so. Other “dirty hands” cue methods may include a proximity sensor, which may be, but is not limited to, a capacitive, Theremin, ultrasonic or infra-red sensor, that may sense close proximity to an object.

Further, the present subject matter teaches that sound may be used as a cue as in the case of the unique sound of a flushing toilet or a person urinating; these sounds may be distinctly different from running water from a faucet. Further, a proper filter, as described in the present disclosure, may be used to sense specific sounds. The combination of a microphone with the proper filter or spectral analyzer may serve as a flushing water or urinating sensor. Further, the phrase “flushing water” may be associated with a toilet.

Further, the device and method of the present disclosure describes odors, which may be, but are not limited to, feces, ammonia or sulfides, that may be utilized by an appropriate chemical sensor, which may be well known in the art, to provide cues to dirty hands or contamination of a person's hands. Further, an odor sensor may be a chemical sensor capable of sensing specific chemical odors. Further, the present subject matter teaches the use of a UV light source that may cause fluorescence of bacteria on the hands with an appropriate photodetector to generate a “dirty hands” signal. The phrase “dirty hands” and “clean hands” may refer to the hand wash state of the user.

Still another embodiment of the present disclosure is a device and method for indicating the hand wash state, which may be, but is not limited to, either dirty or clean, of the user; this embodiment may be comprise of a microprocessor controlled indicator light that may be located on a wrist unit or worn on the lapel of the user. Further, the present subject matter teaches any visual indicator is feasible, which may be, but is not limited to, a stationary or a flashing light/laser/OLED, LCD or reflective display, vane or audio indicators, which may include, but are not limited to, buzzers, bells, beepers, bone conduction transducers and voice recordings, which may be, “Please wash hands” or “Lavas los manos”. Further, any tactile indicator, which may be a silent buzzer, electroshock, thermal or pincer/squeezing device, may be feasible. Hand washing status may be recorded on a flash memory or tape recorder on the unit itself or transmitted to a base unit. Further, the device and method disclosed in the present subject matter describes the transmitting the hand washing state data to a central computer database, which may comprise a wireless link that may connect the microprocessor to a central computer database system.

An alternative embodiment of the present disclosure indicates the hand wash state of the user may use a “count up” timer, which may be in the form of an indicator that may indicate the duration from the last time the user washed their hands. For example, an LCD display may indicate the following message, “I washed my hands XX minutes ago” where XX is the duration in minutes since the last hand washing session; such a method of indication may eliminate a “dirty hands” sensor, thereby thus greatly simplifying the device.

Another embodiment of the present disclosure teaches a method of indication by the use of a stationary proximity sensor near a patient's bed or work area. When the user of the invention approaches the proximity sensor, the sensor may interrogate the wrist unit. If at least one wrist unit is in the “dirty” state, then the stationary proximity sensor may use an audio indication to “Please wash your hands”.

According to yet another embodiment of the present invention, a method of reminding and recording hand hygiene compliance comprises the steps of (a) determining whether a person has washed their hands, and/or (b) determining whether a person has touched any object after washing their hands. The method also optionally comprises the steps of (c) creating a data set, and (d) sending information collected in steps (a and/or b) to the data set.

Further, the present subject matter encompasses present and future known equivalents to the known components referred to herein by way of illustration in the following figures. In the ensuing figures and encompassing specification, an embodiment showing a singular component should not be considered limiting. Rather, the subject matter encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. The listing of embodiments can best be illustrated by the following figures:

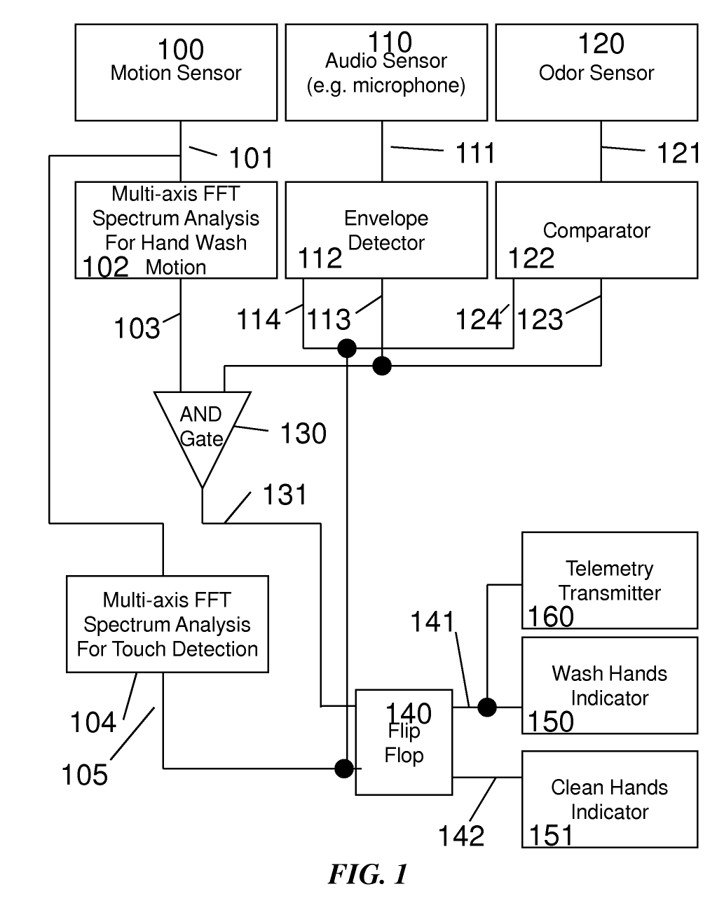

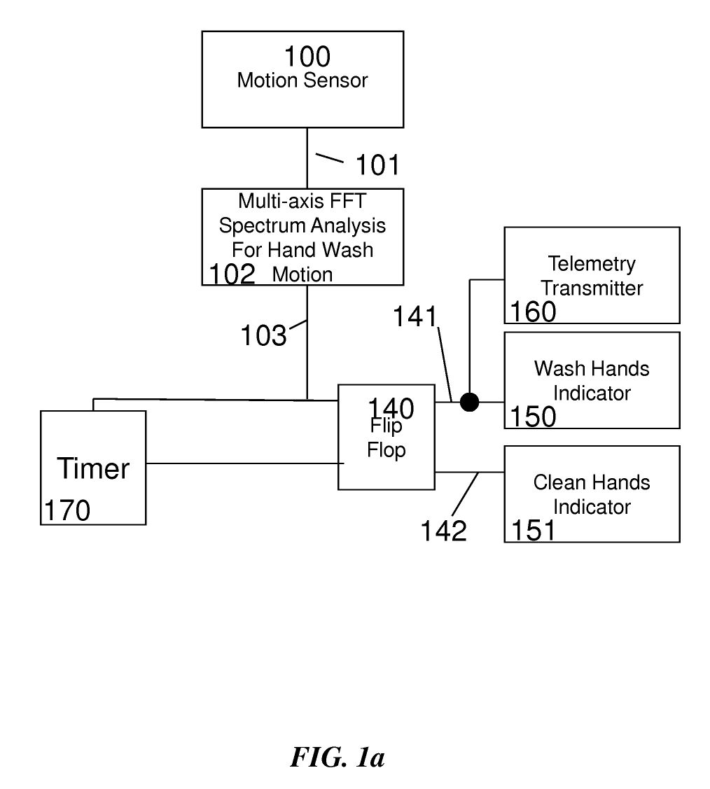

FIG. 1 illustrates a schematic view of the disclosed system according to an embodiment of the present invention. The system may include a set of multi-axis accelerometers, gyroscopes or ultrasonic Doppler velocitometry sensor, herein referred to as a motion sensor set 100. Further, the system may include an audio sensor 110 and an alcohol sensor 120. All of the components illustrated in FIG. 1 may reside on various housings located on the user's body. For example, the entire system may be contained within wrist strap housing and a badge with a cable in between.

Motion sensor set 100 may send a signal 101 to a multi-axis fast Fourier transform (FFT) spectrum analyzer 102. This analyzer 102 may be part of a software package contained in a microcontroller chip which may be, but is not limited to, a Texas Instruments MSP430 microcontroller board. Further, the Texas Instruments MSP430 microcontroller board may have an added advantage of a built in analog to digital converter circuit, which may be contained within the chipset as well as a built in transceiver. Analyzer 102 processes the information obtained from motion sensor set 100 using known methods of data reduction or by matching a previously learned set of acceleration data to determine whether hand washing motion may be occurring. If the analyzer 102 determines that hand washing motion is occurring, it sends a logic “high” signal 103 to logical AND gate 130.

Audio sensor 110 may be in the form of a microphone or piezoelectric vibration sensor or any other known audio transducer convenient for use. The signal 111 from audio sensor 110 may be passed through envelope detector 112. Envelope detector 112 may be designed to detect the sound of running water from a faucet as described in the present disclosure. The envelope detector 112 may send a logic “high” signal 113 to logical AND gate 130 when it detects running water.

Odor sensor 120 may be in the form of a fuel cell or catalytic alcohol sensor or any other known alcohol sensor convenient for use. Odor sensor 120 may also sense the odor of soap, which may be for the “clean hands” detector, and/or feces, ammonia or sulfides, which may be for use as a “dirty hands” detector. Odor sensor 120 must discern between these compounds and may be comprised of multiple sensors. The signal 121 from odor sensor 120 may be passed through comparator 122. Comparator 122 may be designed to detect the voltage that may be generated by consuming alcohol odor in fuel cell sensor 120 as described in the present disclosure. When alcohol is detected by comparator 122, the comparator 122 may send a logic “high” signal 123 to logical AND gate 130.

When motion sensor signal 103 and either audio signal 113 or odor sensor signal 123 are logical “high”, which may be associated with hand motion and water sound or hand motion and alcohol odor, then the output signal 131 of AND gate 130 goes logical “high”. When this occurs, signal 131 changes the logical state of flip-flop 140 to signal 142 “high” which turns on indicator 151 indicating the user has clean hands, which may be the “clean hands” state. Indicator 151 may use an indicator light, audio signal LCD display, tactile signal or any known indication method.

After the device is in the “clean hands” state, specific motion associated with touching an object, as described earlier in the present disclosure, may generate a specific motion spectra sensed by motion sensor set 100. Signal 101, besides being sent to analyzer 102 may also send to a multi-axis FFT spectrum analyzer 104, which may be capable of detecting “touching” motion acceleration spectra. Once the touching motion may be detected by analyzer 104, the analyzer 104 may create a signal 105 “high” that may change the state of flip-flop 140 to signal 141 logical “high” and signal 142 logical “low”. In addition, a specific sound, which may include, but is not limited to, a toilet flushing, may be detected by audio sensor 110 turning signal 114 to logic “high”; thus the state of flip-flop 140 may change to signal 141 logical “high” and signal 142 logical “low”. Also, sensor 120 may also detect a bad odor, which may be associated with, but is not limited to, feces, ammonia, sulfides; the bad odor may turn the signal 124 to logic “high”, which may thereby change the state of flip-flop 140 to signal 141 logical “high” and signal 142 logical “low”. These three signals, 104, 114, 124, in turn may power off clean hands indicator 151 and may power on “wash hands” indicator 150.

Indicator 150 may use an indicator light, audio signal LCD display, or tactile signal, among other known indication methods.

In addition to turning on wash hands indicator 150, signal 141 may optionally send a logic “high” signal to telemetry transmitter 160 to send a signal to a base station for further data analysis purposes and/or data recording.

FIG. 1a illustrates a schematic view of the inventive system according to another preferred embodiment of the present invention. The system may include a set of multi-axis motion sensor set 100. All of the components illustrated in FIG. 1a may reside on various housings located on the user's body. For example, the entire system may be contained within wrist strap housing and a badge with a cable in between.

Multi-axis motion sensor set 100 send a signal 101 to a multi-axis fast Fourier transform (FFT) spectrum analyzer 102. This analyzer 102 may be part of a software package contained in a microcontroller chip, which may be, but is not limited to, a Texas Instruments MSP430 microcontroller board which has an added advantage of having built in analog to digital converter circuits contained within the chipset as well as a built in transceiver. Analyzer 102 may process the information obtained from motion sensor set 100 using known methods of data reduction or by matching a previously learned set of motion data to determine if hand washing motion may be occurring. If analyzer 102 determines that hand washing motion may be occurring, then analyzer 102 may send a logic “high” signal 103 to flip flop 140 and starts timer 170.

When motion sensor signal 103 is logical “high”, which may be associated with hand motion, signal 103 changes the logical state of flip-flop 140 to signal 142 “high”, which turns on indicator 151 indicating the user has clean hands, which may be associated with the “clean hands” state. Indicator 151 may use an indicator light, audio signal LCD display, or tactile signal, among other known indication methods.

After the device is in the “clean hands” state, timer 170 may run for a predetermined duration, which may be, but is not limited to being five minutes, and may send a signal to flip flop 140 changing signal 141 to the “high” state. This condition may turns off the “clean hands” indicator 151 and may turn on the “wash hands” indicator 150.

In addition to turning on wash hands indicator 150, signal 141 may also optionally send a logic “high” signal to telemetry transmitter 160 to send a signal to a base station for further data analysis purposes and/or data recording.

The foregoing description of the preferred embodiments is provided to enable any person skilled in the art that any single or combination of any of the disclosed sensing methods may be used to sense hand washing or be used as a “dirty hands” sensor. The present disclosure is not limited to any single or specific combination of these sensing methods.

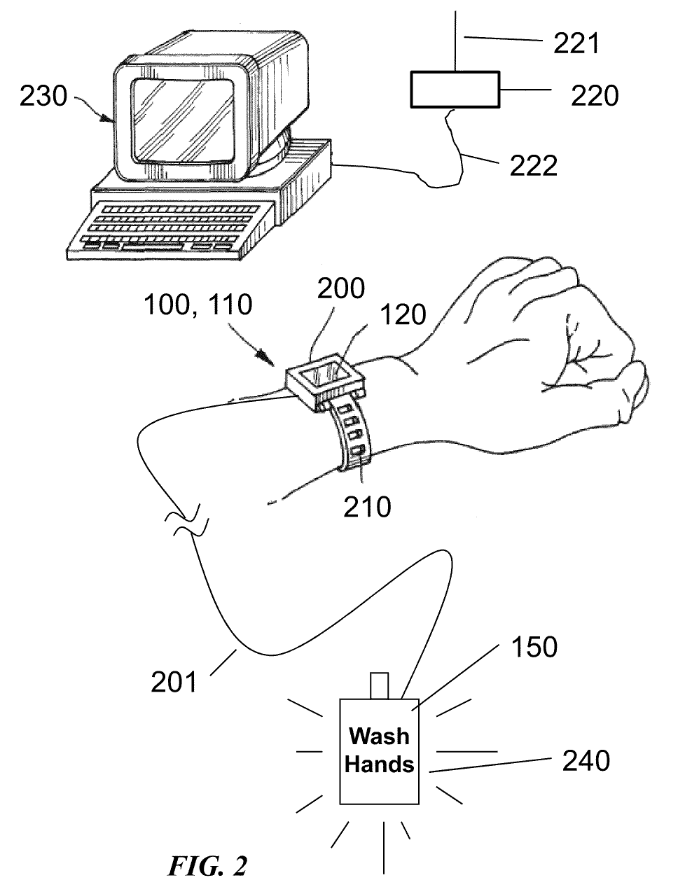

FIG. 2 illustrates a pictorial diagram of the present subject matter in use. Wrist enclosure 200 may contain at minimum motion sensor set 100 but may contain more or all of the components described earlier, which may include, but is not limited to, some form of power supply, which may be a battery. Enclosure 200 may also be located on the forearm of the individual. The power supply may also consist of a solar cell or RF power transmission system. In an embodiment, wrist enclosure 200 may contain motion sensor set 100, audio sensor 110 and odor sensor 120. Wrist enclosure 200 may be affixed to a wrist strap 210 which may retain the wrist enclosure 200 on the wrist of the user. Cable 201 may connect wrist unit 200 with badge unit 240. Optionally, cable 201 may be replaced with a wireless connection. In an embodiment of the present subject matter, badge unit 240 may contain analyzers 102 and 104, envelope detector 112, comparator 122, AND gate 130, flip-flop 140, indicators 150 and 151 and telemetry transmitter 160, as well as some form of battery power supply. Indicators 150 and 151 may provide a “wash hands” or “clean hands” indication for the user and persons surrounding to help remind the user to wash their hands. In an embodiment of the presently disclosed subject matter, two wrist sensors 200 may be utilized to assure both hands are clean. Badge unit 240 may also be located on a belt or armband or any other convenient mounting location on the user's body.

Base unit 230 comprising of a computer or other data storage/processing unit may be connected to receiver 220 via cable 222. Antenna 221 may receive data from badge unit 240, which may be a telemetry transmitter 160.

Another unique method of indication may be by the use of a stationary proximity sensor 230 near a patient's bed or food work area. When the user of the invention approaches the proximity sensor 230 the sensor may interrogate the wrist unit 200. If wrist unit(s) 200 are in the “dirty” state, stationary proximity sensor 230 may use an audio indication to “Please wash your hands”.

Although various embodiments have been discussed, it is to be understood that while certain forms of the present invention, such a device and method for signaling, audio/visual warnings, have been illustrated, the present disclosure may not be limited to the specific forms or arrangements of parts described or shown. Although an inpatient environment has been described herein, the method and system is also applicable to other environments where hygiene may be important, which may include, but is not limited to, food service or day care facilities.

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

The foregoing description of the disclosed embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein. It is contemplated that additional embodiments are within the spirit and true scope of this disclosed method and system as claimed below.

What is claimed is:

1. A method for ensuring hand hygiene compliance, said method comprising the steps of:
sensing whether a person has washed their hands;
determining a hand wash state of said person's hands;
indicating said hand wash state of said person's hands; and
alerting at least one individual of said hand wash state of said person's hands.

2. The method of claim 1, wherein said step of sensing further comprises one or more of the steps of the following:
sensing motion;
sensing water; and
sensing odor.

3. The method of claim 1, wherein said hand wash state is recorded on a data collection system.

4. The method of claim 1, wherein said method comprises at least two of the steps of the following:
sensing motion;
sensing water; and
sensing odor.

5. The method of claim 1, wherein said method comprises the steps of the sensing motion, sensing water, and sensing odor.

6. The method of claim 1, wherein said hand wash state is associated with a nosocomial infection.

7. The method of claim 2, wherein said step of sensing motion is accomplished by one or more of an accelerometer, a gyroscope, or an ultrasonic Doppler sensor.

8. The method of claim 2, wherein said step of sensing water is accomplished by one or more of a running water sensor, a flushing water sensor, or a moisture sensor.

9. The method of claim 2, wherein said step of sensing odor is accomplished by an odor detector.

10. The method of claim 3, wherein said hand wash state is transmitted to said data collection system via at least one of a wired or a wireless data.

11. An apparatus for ensuring hand hygiene compliance, said apparatus comprising:
a sensing device, said sensing device for determining a hand wash state;
an indicating device, said indicating device indicating said hand wash state of said person; and an alerting device, said alerting device alerting at least one individual of said state of hand wash said of said person's hands.

12. The apparatus of claim 11, wherein said sensing device is one or more of the following:
motion sensor;
water sensor; and
odor sensor.

13. The apparatus of claim 11, further comprising a data collection system, said data collection system recording said hand wash state.

14. The apparatus of claim 12 wherein said motion sensor is one or more of an accelerometer, a gyroscope, or an ultrasonic Doppler sensor.

15. The apparatus of claim 12 wherein said water sensor is one or more of a running water sensor, a flushing water sensor, or a moisture sensor.

16. The apparatus of claim 12 wherein said odor sensor is one or more of an alcohol odor sensor or a contaminant odor sensor.

17. The apparatus of claim 12 wherein said apparatus comprises at least two of the following:
motion sensor;
water sensor; and
odor sensor.

18. The apparatus of claim 12 wherein said apparatus comprises a motion sensor, a water sensor, and an odor sensor.

19. The apparatus of claim 13, further comprising at least one of a wired or wireless device to transmit said hand wash state to said data collection system.
